(19) United States
(12) Patent Application Publication
(10) Pub. No.: US 2023/0063368 A1
(43) Pub. Date: Mar. 2, 2023

(54) SELECTING MINIMAL RISK MANEUVERS

(71) Applicant: Motional AD LLC, Boston, MA (US)

(72) Inventor: James Lopez, Pittaburgh, PA (US)

(21) Appl. No.: 17/811,687

(22) Filed: Jul. 11, 2022

Related U.S. Application Data
(60) Provisional application No. 63/237,838, filed on Aug. 27, 2021.

(51) Int. Cl. B60W 60/00; B60W 50/00; B60W 30/09; B60W 30/095; B60W 40/04; G06N 3/04; G06N 7/00

(52) U.S. Cl. CPC B60W 60/0011; B60W 30/09; B60W 30/0956; B60W 40/04; B60W 50/0097; B60W 60/0015; B60W 60/00274; G06N 3/04; G06N 7/005; B60W 2554/20; B60W 2554/40

(57) ABSTRACT

Provided are methods for selection of optimal minimal risk maneuver, which can include receiving at least one first parameter associated with a characteristic of a vehicle and at least one second parameter associated with at least one object external to the vehicle, generating at least one future state for at least one of the first and second parameters, selecting at least one maneuver from a plurality of maneuvers based on the generated future state, determining at least one reward value associated with the selected maneuver, updating the selected maneuver based on the determined reward value to generate an updated maneuver, and operating the vehicle based on the updated maneuver. Systems and computer program products are also provided.

### BACKGROUND

An autonomous vehicle is capable of sensing its surrounding environment and navigating without human input. Upon receiving data representing the environment and/or any other parameters, the vehicle performs processing of the data to determine its movement decisions, e.g., stop, move forward/reverse, turn, etc. The decisions are intended to safely navigate the vehicle along a selected path to avoid obstacles and react to a variety of scenarios, such as, presence, movements, etc. of other vehicles, pedestrians, and/or any other objects.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4A is a diagram of certain components of an autonomous system;

FIG. 4B is a diagram of an implementation of a neural network;

FIGS. 4C and 4D are a diagram illustrating example operation of a CNN;

FIG. 5A illustrates an example of a system for selecting an optimal minimal risk maneuver (“MRM”), according to some embodiments of the current subject matter;

FIG. 5B illustrates an alternate implementation of a system for selecting an optimal MRM, according to some embodiments of the current subject matter

FIG. 6 illustrates an exemplary method for selecting an optimal MRM, according to some embodiments of the current subject matter; and

FIG. 7 illustrates an exemplary method for training a model for selection of an optimal MRM, according to some embodiments of the current subject matter.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

A vehicle (e.g., an autonomous vehicle) includes sensors that monitor various parameters associated with the vehicle. For example, some sensors (e.g., cameras, LIDAR sensors, RADAR sensors, SONAR sensors, etc.) monitor/detect changes occurring in the vehicle’s environment (e.g., actions and/or presence of other vehicles, pedestrians, street lights, etc.). Other (e.g., health status) sensors monitor/detect various aspects associated with operational abilities of the vehicle (e.g., heading, speed, mechanical operation, etc.). Each sensor transmits gathered data to vehicle’s monitor/control system(s).

Using the received data, vehicle’s control system(s) predict future values of each (or selected) monitored parameters, and using actual and predicted values of the parameters, determine an optimal minimal risk maneuver (MRM) for the vehicle to execute. The optimal MRM can be selected from a plurality of stored MRMs. A reward for the selected MRM can be assigned in accordance with a Markov Decision Process’s reward function. A positive reward (e.g., motivation) can be assigned for the correctly selected MRM, whereas a negative reward can be assigned for an incorrectly or unnecessarily selected/used MRM, and an infinitely negative reward for an MRM that results in, for example, an accident. Rewards may be assigned using rules that may be stored by the vehicle’s control systems.

Additionally, a training process (e.g., during simulation) may be executed to determine an optimal MRM. The training may be based on a continuous feed of data values associated with monitored parameters. The MRMs may be refined based on the continued simulations and invoked at drive time.

In some embodiments, one or more processors (e.g., arbitration unit, system controller, etc.) receive at least one first parameter associated with a characteristic of a vehicle and at least one second parameter associated with at least one object (e.g., other vehicles, pedestrians, etc. that can be external to the vehicle. The processor(s) generate at least one future state for at least one of the first and second parameters and select at least one maneuver (e.g., MRM) from a plurality of such maneuvers based on the generated future state. The processor(s) determine at least one reward value associated with the selected maneuver. The processor(s) update the selected maneuver based on the determined reward value to generate an updated maneuver. The vehicle is then operated based on the updated maneuver.

In some embodiments, the current subject matter can include one or more of the following optional features. Determination of the reward includes the vehicle’s processor(s) determining at least one reward value using a reinforcement learning process. The vehicle’s processor(s) execute the reinforcement learning process based on at least one rule associated with operating of the vehicle. At least one reward includes at least one of the following: a maximum negative reward for violating the at least one rule, a negative reward for operating the vehicle in an unnecessary manner, a positive reward, and any combination thereof.

In some embodiments, the first parameter can include at least one of a current state and a predicted future state associated with operation of the vehicle. The second parameter includes at least one of a current state and a predicted future state associated with the object.

In some embodiments, receiving of the parameters includes the vehicle’s processor(s) receiving data corresponding to at least one stochastic measurement associated with at least one of the first and second parameters. For example, the first parameter and/or the second parameter include at least one of the following: a speed, a position, an acceleration, a direction of movement, and any combination thereof. At least one object includes at least one of the following: at least one another vehicle, at least one moving object, at least one stationary object, and any combination thereof.

In some embodiments, receiving of the parameters includes the vehicle’s processor(s) receiving at least one third parameter associated with an operational ability of the vehicle. Selection of the maneuver includes the vehicle’s processor(s) selecting the maneuver based on the determined at least one future state and the third parameter.

In some embodiments, generation of the prediction of future states of the first and/or second parameters includes the vehicle’s processor(s) modeling at least one of the first and/or second parameters to generate at least one future state. The modeling includes the vehicle’s processor(s) modeling at least one of the first and/or second parameters using a Markov decision process.

In some aspects and/or embodiments, systems, methods, and computer program products described herein include and/or implement training of a MRM model that is used by a vehicle (e.g., an autonomous vehicle) to select an optimal MRM. Model training is performed during simulation (e.g., when the vehicle is not driving/operating or when the vehicle is driving/operating but not using the model to select an optimal MRM). Selection of the optimal MRM is performed while the vehicle is driving/operating. In some embodiments, to train the MRM model, one or more processors (e.g., arbitration unit, system controller, etc.) receive at least one first parameter associated with a characteristic of a vehicle and at least one second parameter associated with at least one object external to the vehicle. The processor(s) determine at least one future state for at least one of the first and second parameters and train at least one MRM model e.g., MRM model] using at least one of the first and second parameters.

In some embodiments, the current subject matter can include one or more of the following optional features. The training process includes the vehicle’s processor(s) generating at least maneuver based on the trained model to operate the vehicle.

As stated above, the first parameter includes at least one of a current state and a predicted future state associated with the vehicle, and the second parameter includes at least one of a current state and a predicted future state associated with the object. Further, the receiving of parameters includes the vehicle’s processor(s) continuously receiving at least one of the first and/or second parameters. The training includes the vehicle’s processor(s) continuously training the model using continuously received first and/or second parameters.

In some embodiments, generation of the maneuver includes the vehicle’s processor(s) selecting the maneuver from a plurality of maneuvers, and generating at least one trigger signal associated with the selected at least one maneuver can be used to operate the vehicle. Upon the trigger signal indicating that the selected maneuver can be used to operate the vehicle, the vehicle’s processor(s) operate the vehicle using the maneuver. However, upon the trigger signal indicating that the selected maneuver cannot be used to operate the vehicle, the vehicle’s processor(s) prevent operation of the vehicle using the selected maneuver and select at least another maneuver from the plurality of maneuvers based on the generated trigger signal to operate the vehicle.

In some embodiments, generating of at least one maneuver includes the vehicle’s processor(s) at least one maneuver while the vehicle is operating.

In some embodiments, receiving of the data includes the vehicle’s processor(s) receiving data corresponding to at least one stochastic measurement associated with at least one of the first and/or second parameters. At least one of first and/or second parameters include at least one of the following: a speed, a position, an acceleration, a direction of movement, and any combination thereof. As stated above, the object includes at least one of the following: at least one another vehicle, at least one moving object, at least one stationary object, and any combination thereof.

By virtue of the implementation of systems, methods, and computer program products described herein, techniques for selecting an optimal MRM as well as training an MRM model that is used by the vehicle to select such optimal MRM during driving/operation. In particular, the current subject matter allows dynamic selection of MRMs based on vehicle’s parameters and/or environment (that may closely resemble what an actual driver may do). It also avoids selection/use of unintended/unnecessary MRMs that can result in detrimental consequences (e.g., accidents, etc.).

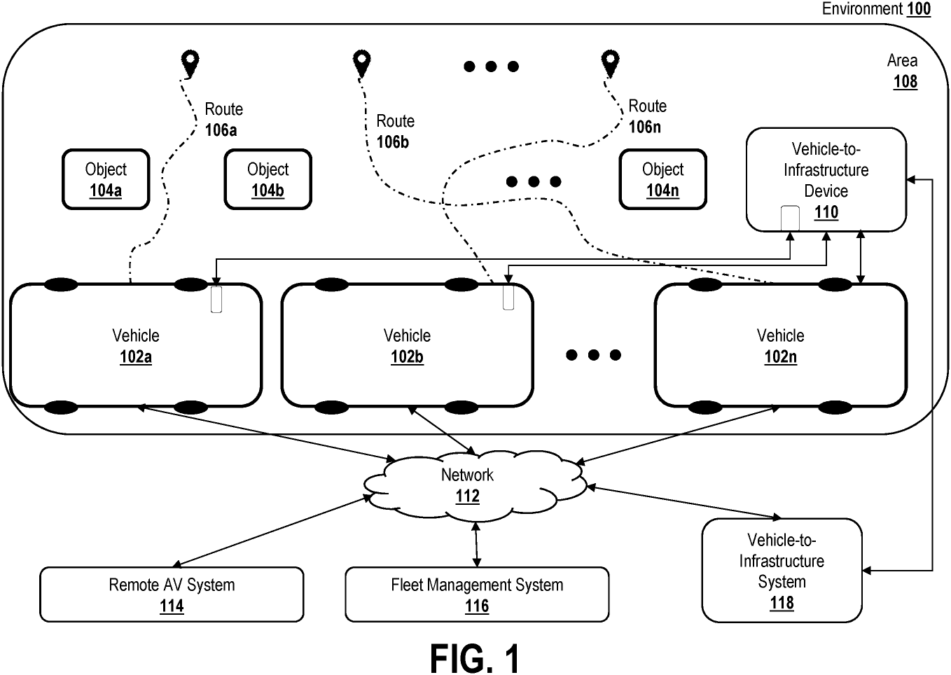

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

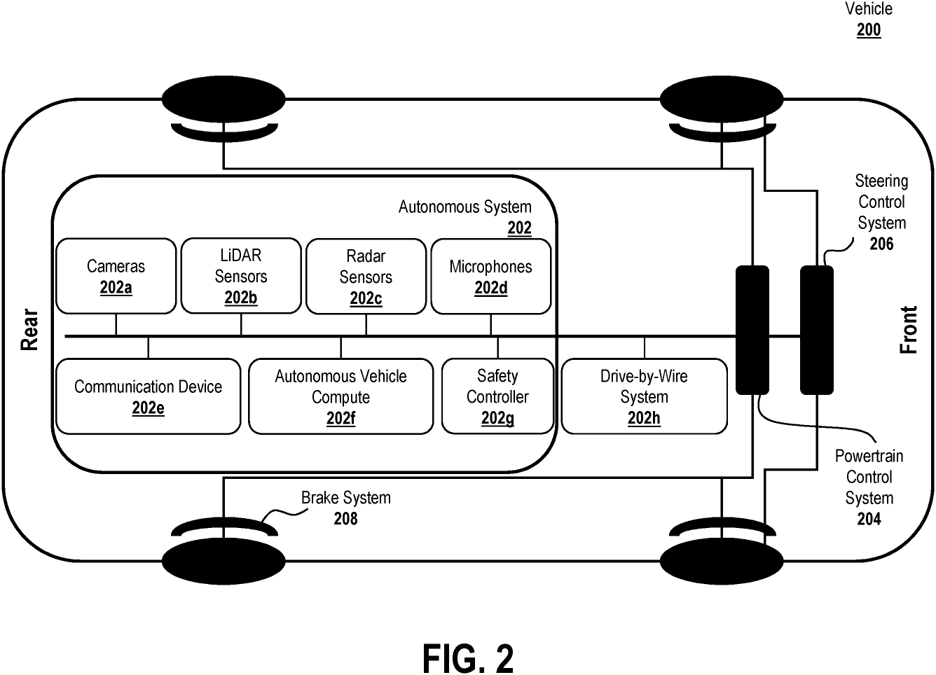

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International’s standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

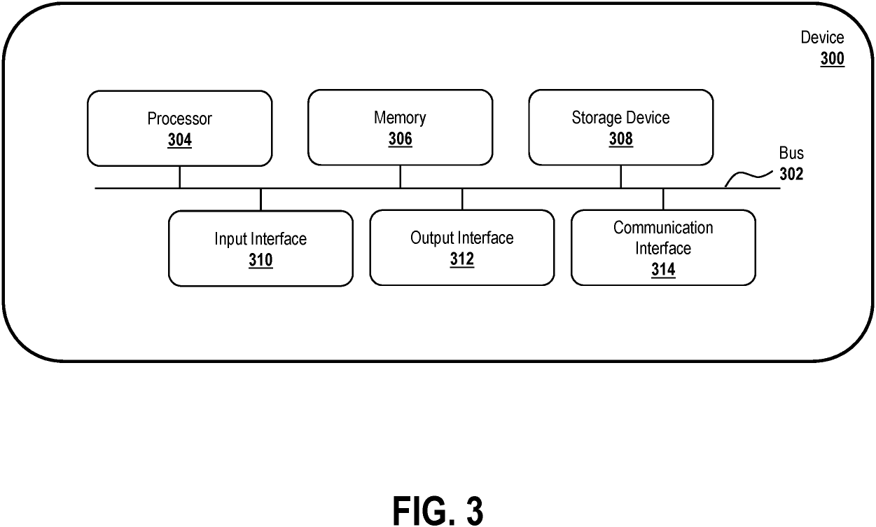

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of other devices/objects shown in FIG. 1, and/or one or more devices of network 112 (e.g., one or more devices of a system of network 112). In some embodiments, one or more devices of vehicles 102 (e.g., one or more devices of a system of vehicles 102), at least one device of other devices/objects shown in FIG. 1, and/or one or more devices of network 112 (e.g., one or more devices of a system of network 112) include at least one device 300 and/or at least one component of device 300.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi^{®} interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

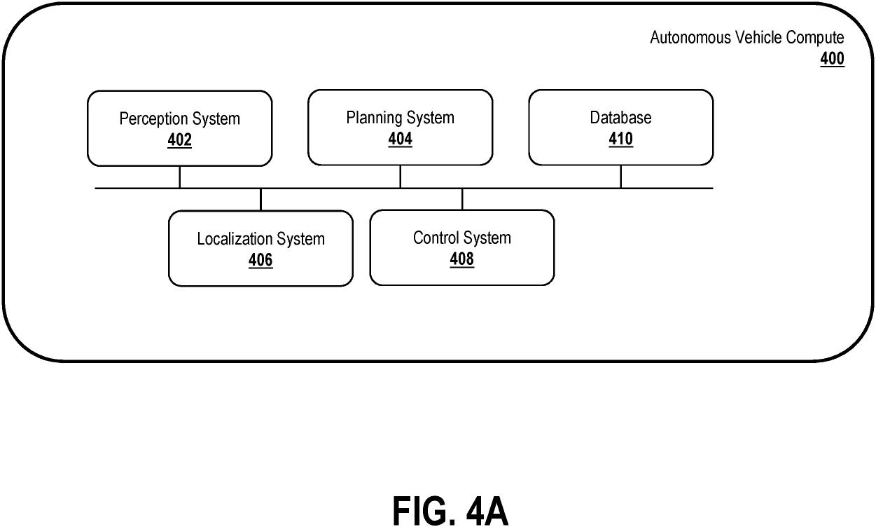

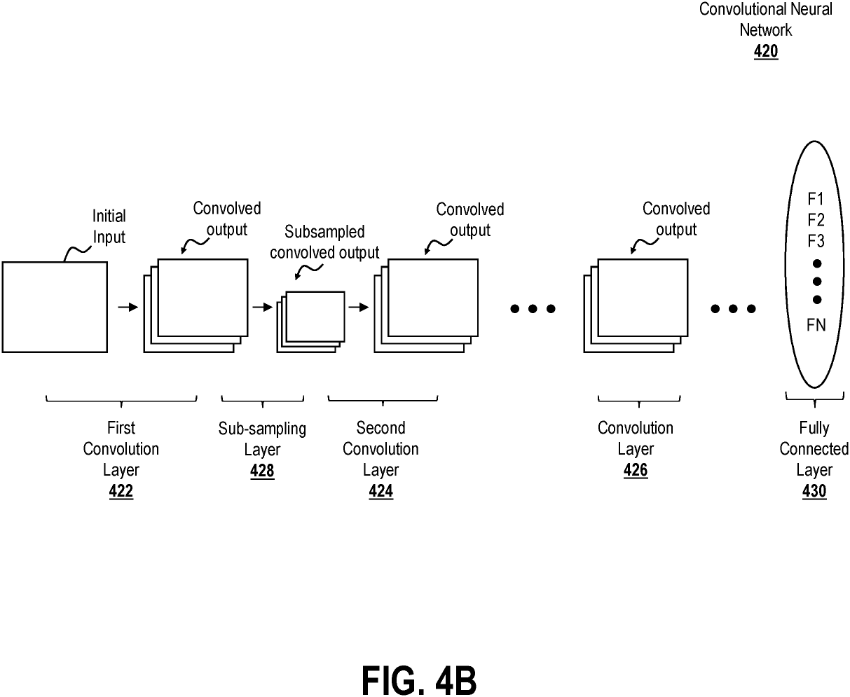

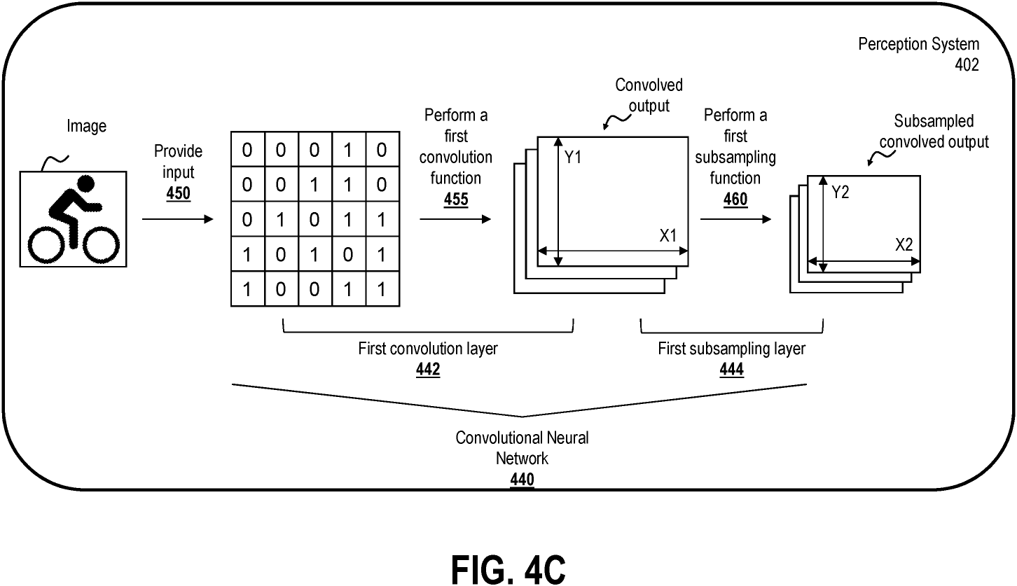

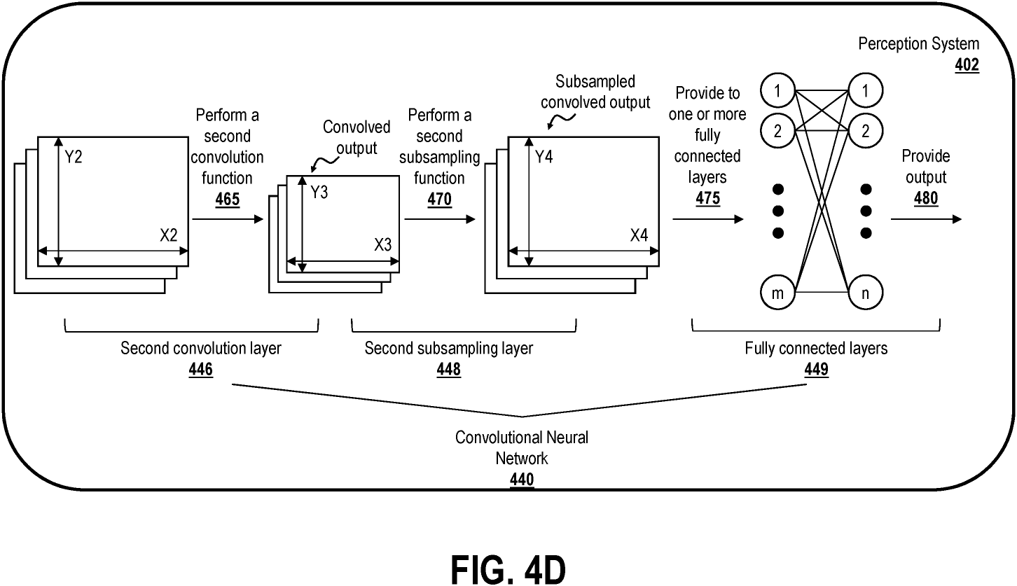

Referring now to FIG. 4A, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

Referring now to FIG. 4B, illustrated is a diagram of an implementation of a machine learning model. More specifically, illustrated is a diagram of an implementation of a convolutional neural network (CNN) 420. For purposes of illustration, the following description of CNN 420 will be with respect to an implementation of CNN 420 by perception system 402. However, it will be understood that in some examples CNN 420 (e.g., one or more components of CNN 420) is implemented by other systems different from, or in addition to, perception system 402 such as planning system 404, localization system 406, and/or control system 408. While CNN 420 includes certain features as described herein, these features are provided for the purpose of illustration and are not intended to limit the present disclosure.

CNN 420 includes a plurality of convolution layers including first convolution layer 422, second convolution layer 424, and convolution layer 426. In some embodiments, CNN 420 includes sub-sampling layer 428 (sometimes referred to as a pooling layer). In some embodiments, sub-sampling layer 428 and/or other subsampling layers have a dimension (i.e., an amount of nodes) that is less than a dimension of an upstream system. By virtue of sub-sampling layer 428 having a dimension that is less than a dimension of an upstream layer, CNN 420 consolidates the amount of data associated with the initial input and/or the output of an upstream layer to thereby decrease the amount of computations necessary for CNN 420 to perform downstream convolution operations. Additionally, or alternatively, by virtue of sub-sampling layer 428 being associated with (e.g., configured to perform) at least one subsampling function (as described below with respect to FIGS. 4C and 4D), CNN 420 consolidates the amount of data associated with the initial input.

Perception system 402 performs convolution operations based on perception system 402 providing respective inputs and/or outputs associated with each of first convolution layer 422, second convolution layer 424, and convolution layer 426 to generate respective outputs. In some examples, perception system 402 implements CNN 420 based on perception system 402 providing data as input to first convolution layer 422, second convolution layer 424, and convolution layer 426. In such an example, perception system 402 provides the data as input to first convolution layer 422, second convolution layer 424, and convolution layer 426 based on perception system 402 receiving data from one or more different systems (e.g., one or more systems of a vehicle that is the same as or similar to vehicle 102), a remote AV system that is the same as or similar to remote AV system 114, a fleet management system that is the same as or similar to fleet management system 116, a V2I system that is the same as or similar to V2I system 118, and/or the like). A detailed description of convolution operations is included below with respect to FIG. 4C.

In some embodiments, perception system 402 provides data associated with an input (referred to as an initial input) to first convolution layer 422 and perception system 402 generates data associated with an output using first convolution layer 422. In some embodiments, perception system 402 provides an output generated by a convolution layer as input to a different convolution layer. For example, perception system 402 provides the output of first convolution layer 422 as input to sub-sampling layer 428, second convolution layer 424, and/or convolution layer 426. In such an example, first convolution layer 422 is referred to as an upstream layer and sub-sampling layer 428, second convolution layer 424, and/or convolution layer 426 are referred to as downstream layers. Similarly, in some embodiments perception system 402 provides the output of sub-sampling layer 428 to second convolution layer 424 and/or convolution layer 426 and, in this example, sub-sampling layer 428 would be referred to as an upstream layer and second convolution layer 424 and/or convolution layer 426 would be referred to as downstream layers.

In some embodiments, perception system 402 processes the data associated with the input provided to CNN 420 before perception system 402 provides the input to CNN 420. For example, perception system 402 processes the data associated with the input provided to CNN 420 based on perception system 420 normalizing sensor data (e.g., image data, LiDAR data, radar data, and/or the like).

In some embodiments, CNN 420 generates an output based on perception system 420 performing convolution operations associated with each convolution layer. In some examples, CNN 420 generates an output based on perception system 420 performing convolution operations associated with each convolution layer and an initial input. In some embodiments, perception system 402 generates the output and provides the output as fully connected layer 430. In some examples, perception system 402 provides the output of convolution layer 426 as fully connected layer 430, where fully connected layer 420 includes data associated with a plurality of feature values referred to as F1, F2 ... FN. In this example, the output of convolution layer 426 includes data associated with a plurality of output feature values that represent a prediction.

In some embodiments, perception system 402 identifies a prediction from among a plurality of predictions based on perception system 402 identifying a feature value that is associated with the highest likelihood of being the correct prediction from among the plurality of predictions. For example, where fully connected layer 430 includes feature values F1, F2, ... FN, and F1 is the greatest feature value, perception system 402 identifies the prediction associated with F1 as being the correct prediction from among the plurality of predictions. In some embodiments, perception system 402 trains CNN 420 to generate the prediction. In some examples, perception system 402 trains CNN 420 to generate the prediction based on perception system 402 providing training data associated with the prediction to CNN 420.

Referring now to FIGS. 4C and 4D, illustrated is a diagram of example operation of CNN 440 by perception system 402. In some embodiments, CNN 440 (e.g., one or more components of CNN 440) is the same as, or similar to, CNN 420 (e.g., one or more components of CNN 420) (see FIG. 4B).

At step 450, perception system 402 provides data associated with an image as input to CNN 440 (step 450). For example, as illustrated, perception system 402 provides the data associated with the image to CNN 440, where the image is a greyscale image represented as values stored in a two-dimensional (2D) array. In some embodiments, the data associated with the image may include data associated with a color image, the color image represented as values stored in a three-dimensional (3D) array. Additionally, or alternatively, the data associated with the image may include data associated with an infrared image, a radar image, and/or the like.

At step 455, CNN 440 performs a first convolution function. For example, CNN 440 performs the first convolution function based on CNN 440 providing the values representing the image as input to one or more neurons (not explicitly illustrated) included in first convolution layer 442. In this example, the values representing the image can correspond to values representing a region of the image (sometimes referred to as a receptive field). In some embodiments, each neuron is associated with a filter (not explicitly illustrated). A filter (sometimes referred to as a kernel) is representable as an array of values that corresponds in size to the values provided as input to the neuron. In one example, a filter may be configured to identify edges (e.g., horizontal lines, vertical lines, straight lines, and/or the like). In successive convolution layers, the filters associated with neurons may be configured to identify successively more complex patterns (e.g., arcs, objects, and/or the like).

In some embodiments, CNN 440 performs the first convolution function based on CNN 440 multiplying the values provided as input to each of the one or more neurons included in first convolution layer 442 with the values of the filter that corresponds to each of the one or more neurons. For example, CNN 440 can multiply the values provided as input to each of the one or more neurons included in first convolution layer 442 with the values of the filter that corresponds to each of the one or more neurons to generate a single value or an array of values as an output. In some embodiments, the collective output of the neurons of first convolution layer 442 is referred to as a convolved output. In some embodiments, where each neuron has the same filter, the convolved output is referred to as a feature map.

In some embodiments, CNN 440 provides the outputs of each neuron of first convolutional layer 442 to neurons of a downstream layer. For purposes of clarity, an upstream layer can be a layer that transmits data to a different layer (referred to as a downstream layer). For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of first subsampling layer 444. In some embodiments, CNN 440 adds a bias value to the aggregates of all the values provided to each neuron of the downstream layer. For example, CNN 440 adds a bias value to the aggregates of all the values provided to each neuron of first subsampling layer 444. In such an example, CNN 440 determines a final value to provide to each neuron of first subsampling layer 444 based on the aggregates of all the values provided to each neuron and an activation function associated with each neuron of first subsampling layer 444.

At step 460, CNN 440 performs a first subsampling function. For example, CNN 440 can perform a first subsampling function based on CNN 440 providing the values output by first convolution layer 442 to corresponding neurons of first subsampling layer 444. In some embodiments, CNN 440 performs the first subsampling function based on an aggregation function. In an example, CNN 440 performs the first subsampling function based on CNN 440 determining the maximum input among the values provided to a given neuron (referred to as a max pooling function). In another example, CNN 440 performs the first subsampling function based on CNN 440 determining the average input among the values provided to a given neuron (referred to as an average pooling function). In some embodiments, CNN 440 generates an output based on CNN 440 providing the values to each neuron of first subsampling layer 444, the output sometimes referred to as a subsampled convolved output.

At step 465, CNN 440 performs a second convolution function. In some embodiments, CNN 440 performs the second convolution function in a manner similar to how CNN 440 performed the first convolution function, described above. In some embodiments, CNN 440 performs the second convolution function based on CNN 440 providing the values output by first subsampling layer 444 as input to one or more neurons (not explicitly illustrated) included in second convolution layer 446. In some embodiments, each neuron of second convolution layer 446 is associated with a filter, as described above. The filter(s) associated with second convolution layer 446 may be configured to identify more complex patterns than the filter associated with first convolution layer 442, as described above.

In some embodiments, CNN 440 performs the second convolution function based on CNN 440 multiplying the values provided as input to each of the one or more neurons included in second convolution layer 446 with the values of the filter that corresponds to each of the one or more neurons. For example, CNN 440 can multiply the values provided as input to each of the one or more neurons included in second convolution layer 446 with the values of the filter that corresponds to each of the one or more neurons to generate a single value or an array of values as an output.

In some embodiments, CNN 440 provides the outputs of each neuron of second convolutional layer 446 to neurons of a downstream layer. For example, CNN 440 can provide the outputs of each neuron of first convolutional layer 442 to corresponding neurons of a subsampling layer. In an example, CNN 440 provides the outputs of each neuron of first convolutional layer 442 to corresponding neurons of second subsampling layer 448. In some embodiments, CNN 440 adds a bias value to the aggregates of all the values provided to each neuron of the downstream layer. For example, CNN 440 adds a bias value to the aggregates of all the values provided to each neuron of second subsampling layer 448. In such an example, CNN 440 determines a final value to provide to each neuron of second subsampling layer 448 based on the aggregates of all the values provided to each neuron and an activation function associated with each neuron of second subsampling layer 448.

At step 470, CNN 440 performs a second subsampling function. For example, CNN 440 can perform a second subsampling function based on CNN 440 providing the values output by second convolution layer 446 to corresponding neurons of second subsampling layer 448. In some embodiments, CNN 440 performs the second subsampling function based on CNN 440 using an aggregation function. In an example, CNN 440 performs the first subsampling function based on CNN 440 determining the maximum input or an average input among the values provided to a given neuron, as described above. In some embodiments, CNN 440 generates an output based on CNN 440 providing the values to each neuron of second subsampling layer 448.

At step 475, CNN 440 provides the output of each neuron of second subsampling layer 448 to fully connected layers 449. For example, CNN 440 provides the output of each neuron of second subsampling layer 448 to fully connected layers 449 to cause fully connected layers 449 to generate an output. In some embodiments, fully connected layers 449 are configured to generate an output associated with a prediction (sometimes referred to as a classification). The prediction may include an indication that an object included in the image provided as input to CNN 440 includes an object, a set of objects, and/or the like. In some embodiments, perception system 402 performs one or more operations and/or provides the data associated with the prediction to a different system, described herein.

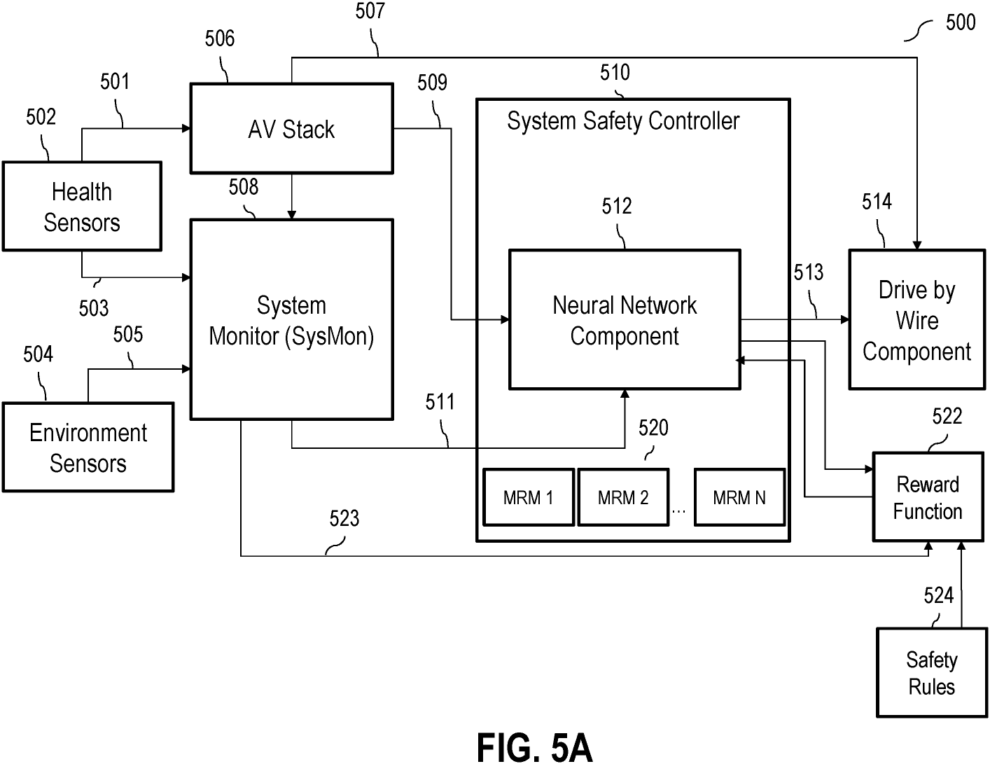

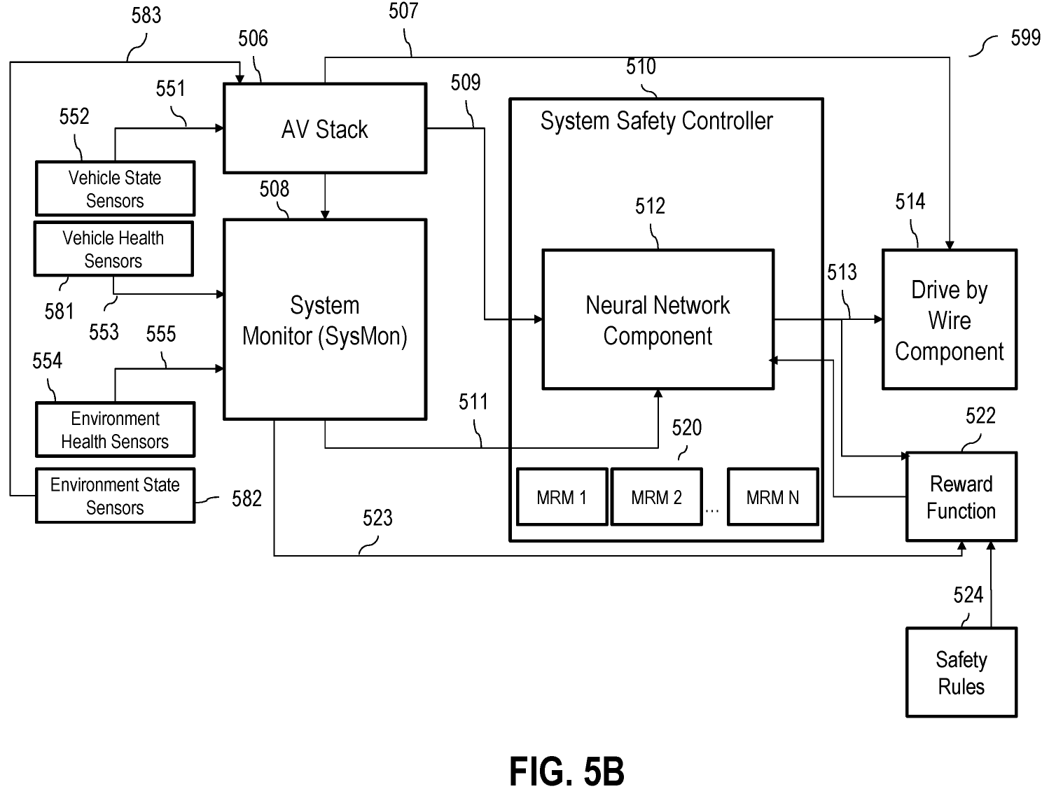

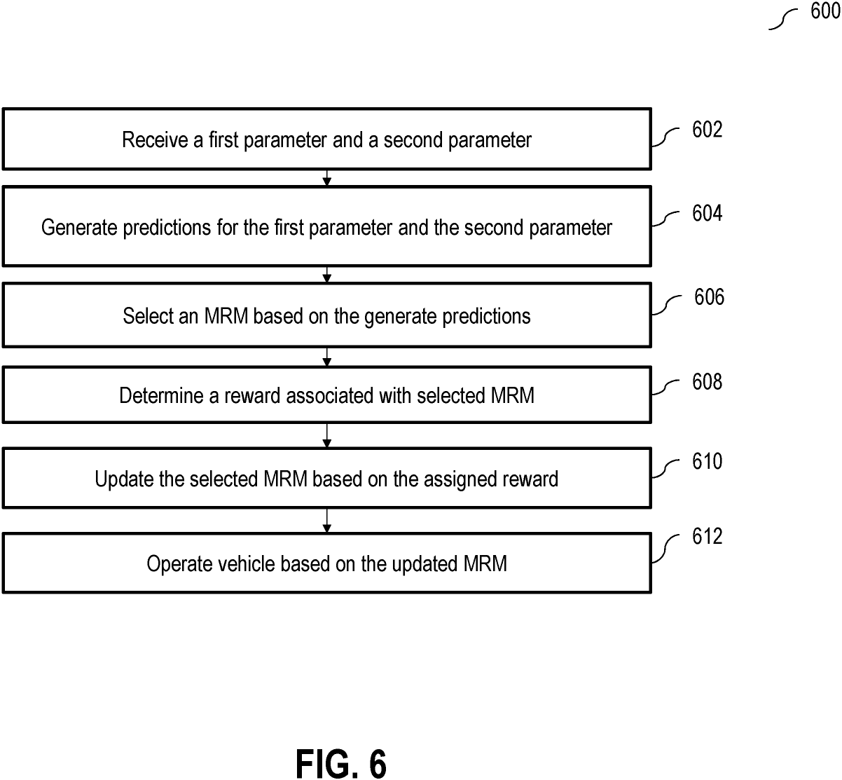

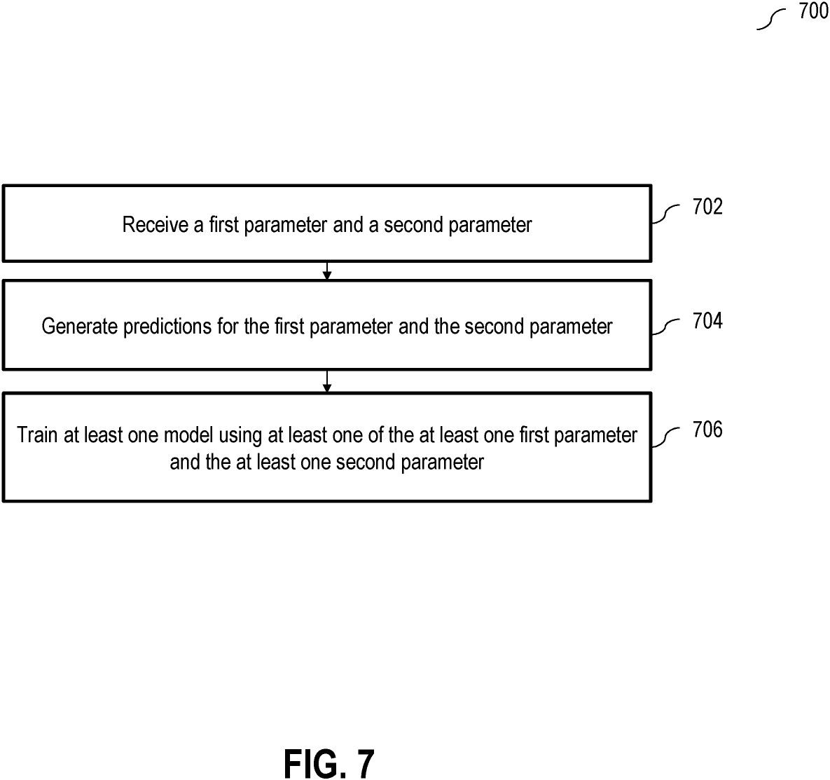

Referring now to FIGS. 5A-5B, illustrated are diagrams of an implementation of a system for selecting an optimal MRM (e.g., from a finite number of MRMs that may be stored by the vehicle) as well as training an MRM model for use in selecting an optimal MRM during vehicle driving/operation. FIG. 6 is a flow chart illustrating an example of a process for selecting an optimal MRM by a vehicle. FIG. 7 is a flow chart illustrate an example of a process for training a MRM model for the purposes of selection of the optimal MRM during driving/operating of the vehicle.

As stated above, a vehicle (e.g., an autonomous vehicle) includes sensors that monitor various parameters associated with the vehicle. For example, some sensors (e.g., cameras, LIDAR sensors, RADAR sensors, SONAR sensors, etc.) monitor/detect changes occurring in the vehicle’s environment (e.g., actions and/or presence of other vehicles, pedestrians, street lights, etc.). Other (e.g., vehicle state) sensors monitor/detect various aspects associated with operational aspects of the vehicle (e.g., heading, speed, mechanical operation, etc.). These types of sensors are referred to as environmental state and vehicle state sensors. Each sensor transmits gathered data to vehicle’s autonomous vehicle (AV) stack, which uses the information from these sensors to autonomously drive the vehicle.

Another set of sensors are referred to as health sensors which measure the health of the vehicle (vehicle health sensors) as well as the ability of environmental sensors (e.g. camera, LIDAR sensors, RADAR sensors, SONAR sensors, etc.) to properly represent the current environment in which the vehicle is operating (e.g., a camera may be fully or partially blocked or a LIDAR sensors has become non-functioning). These health sensors' data is transmitted to a system monitor (SysMon) where an overall assessment of the vehicle’s ability to drive autonomously in the environment is performed.

Using the received data, vehicle’s control system(s) (e.g., within the AV stack) predict future values of each (and/or selected) of the monitored parameters, and using actual and predicted values of these parameters, determine an optimal MRM for the vehicle to execute. The control system(s) select an optimal MRM from a plurality of MRMs that are stored by the vehicle. The control system(s) assign a reward for the selected MRM, for example, in accordance with a Markov Decision Process’s reward function. A positive reward (e.g., motivation) is assigned for the correctly selected MRM. A negative reward is assigned for an incorrectly or unnecessarily selected/used MRM. An infinitely negative reward is assigned for an MRM that results in, for example, an accident. Rewards are assigned using rules that are stored by the vehicle’s control systems. The control system(s) use assigned rewards to determine whether or not a specific situation warrants use of the MRM with such a reward assigned.

Additionally, in some embodiments, the control system(s) execute a training process (e.g., that can be performed during simulation (e.g., when the vehicle is not driving/operating) and/or during vehicle’s drive time/operation) to train an MRM model for use by the vehicle in determining an optimal MRM. The training is based on a continuous feed of data values associated with the monitored parameters. The MRMs are refined based on the continued simulations and invoked at drive time.

FIG. 5A illustrates an example of a system 500 for selecting an optimal MRM, according to some embodiments of the current subject matter. The system 500 can be incorporated into a vehicle (e.g., vehicle 102 shown in FIG. 1, vehicle 200 shown in FIG. 2, etc.). The system 500 includes one or more health sensors 502, one or more environment sensors, an AV stack 506, a system monitor (SysMon) 508, a system safety controller 510, and a drive-by-wire component 514. The system 500 can also incorporate a reward function component 522 and a safety rules component 524, one or both of which can be stored by the vehicle’s systems.

The system safety controller 510 includes a neural network component 512 (similar to those discussed in connection with FIGS. 4B-D above) and stores one or more MRMs (MRM 1, MRM 2, ... MRM N) 520. The MRMs can be stored as a set of instructions that can be used by the vehicle during drive time to execute a particular maneuver. The neural network component (or “neural network”) 512 is trained to select an optimal MRM in view of the vehicle’s health, environment, and/or any other parameters that are being monitored by the vehicle’s systems, which serve as inputs to the neural network 512. The neural network 512 is trained during simulation (e.g., when the vehicle is not driving/operating). The training involves conducting simulations of multiple (e.g., thousands, millions, etc.) scenarios involving the vehicle and/or any other objects (e.g., other vehicles, pedestrians, street poles, and/or any other movable and/or immovable objects) that may be present in the vehicle’s surrounding environment. During training, the neural network 512 can be rewarded for selecting MRMs that result in the safest operation (e.g., avoiding collisions, unsafe situations, etc.) of the vehicle and/or other objects. The neural network 512 can also be rewarded for avoiding execution of unnecessary MRMs (e.g., changing a driving lane of the vehicle when no need to do so exists, etc.).

The vehicle’s health sensors 502 monitor various parameters associated with the vehicles. The parameters can include, but are not limited to, parameters associated with vehicle’s state, e.g., heading, driving speed, etc. Additionally, the parameters can include, but are not limited to, parameters associated with vehicle’s health, e.g., tire inflation pressure, oil level, transmission fluid temperature, etc. In some embodiments, as, for example, is shown in FIG. 5B and discussed below, the vehicle includes separate sensors that measure/monitor vehicle’s state and vehicle’s health. The sensors 502 supply data for one or more measured/monitored parameters to the AV stack 506, at 501, and system monitor 508, at 503.

The vehicle’s environment sensors (e.g., camera, LIDAR, SONAR, etc.) 504 monitor various parameters associated an environment surrounding the vehicle. The parameters include environment’s state and/or health parameters. These parameters can include, but are not limited to, parameters associated with other vehicles (e.g., speed, direction, etc.) and/or other objects (e.g., pedestrian stepping out on a roadway in front of the vehicle). In some embodiments, as, for example, is shown in FIG. 5B and discussed below, the vehicle includes separate sensors that measure/monitor environment’s state and health. The sensors 504 supply data for one or more measured/monitored parameters to the system monitor 508, at 505.

As discussed above, the AV stack 506 controls the vehicle during driving/operation. Additionally, the AV stack 506 provides various MRM trajectories (e.g., stop in lane, pull over, etc.) to the system safety controller 510, at 509, and provides one or more signals (including signals associated with execution of a selected MRM) 507 to the drive by wire component 514. The drive by wire component 514 uses these signals to operate the vehicle.

The system monitor 508 receives vehicle and environment data 503, 505 from the sensors 502, 504, respectively. It then processes the data and supplies to the system safety controller 510, and in particular, to the neural network component 512, at 511. The neural network component 512 uses data 509, 511, as received from the AV stack 506 and system monitor 508, respectively to select and/or determine an optimal MRM 520 for the vehicle. Once the optimal MRM 520 has been determined by the neural network component 512, the controller 510 transmits one or more signals 513 indicative of the selected MRM 520 to the drive by wire component 514.

In some embodiments, one or more MRMs 520 can be pre-loaded/pre-stored by the system 500 (e.g., stop at a stop sign, stop a red light, etc.). Moreover, the system safety controller 510 can, such as, during training of the neural network component 512, generate and store further MRMs 520 and/or refine the pre-loaded/pre-stored MRMs as well as refine generated MRMs upon receiving further sensor data and/or any other information associated with the vehicle’s health, environment, etc. In addition to the provided sensor data and/or pre-loaded/pre-stored MRMs, training of the neural network component 512 can implement one or more safety rules 524 and reward values provided by the reward function 522. Reward values are generated based on the data 523 (e.g., vehicle’s state and/or health, environment’s state and/or health, etc.) supplied to the reward function 522 from the system monitor 508, any MRMs that may have been selected, as well as safety rules 524.

FIG. 5B illustrates an alternate implementation of a system (which can be incorporated into a vehicle (e.g., vehicle 102 shown in FIG. 1, vehicle 200 shown in FIG. 2, etc.)) for selecting an optimal MRM, according to some embodiments of the current subject matter. As shown in FIG. 5B, the system 599 includes one or more vehicle state sensors 552, one or more vehicle health sensors 581, one or more environment health sensors 554, one or more environment state sensor 582, the AV stack 506, the system monitor 508, the system safety controller 510, and the drive-by-wire component 514. Similar to the system 500 shown in FIG. 5A, the system 599 can include the reward function component 522 and the safety rules component 524, one or both of which can be stored by the vehicle’s systems.

Again, similar to the system 500, the system safety controller 510 includes the neural network component 512 and stores one or more MRMs 520, which can include a set of instructions for use by the vehicle during drive time to execute a particular maneuver. The neural network component (or “neural network”) 512 is trained to select an optimal MRM in view of the vehicle’s health, state, environment, and/or any other parameters that are being monitored by the vehicle’s systems, which serve as inputs to the neural network 512.

In the system 599, the vehicle’s state sensors 552 monitor various parameters associated with the state of the vehicle, e.g., speed, heading, mechanical characteristics, etc., and provide data 551 resulting from the monitoring to the AV stack 506. The vehicle’s health sensor 581 monitor various parameters associated with mechanical or other condition of the vehicle (e.g., “health”). The parameters can relate to, for example, operational status of vehicle’s systems, such as, engine, transmission, tires, mechanical issues, etc. The data 553 that results from such monitoring is provided to the system monitor 508.

The environment state sensors 582 can include, for example, a camera, a LIDAR, RADAR, etc., detect and/or monitor various parameters associated with a surrounding environment of the vehicle. The environment can include, for example, pedestrians, other vehicles, objects (movable and/or immovable), etc. The sensors 582 provide data 583 that results from such detections/monitoring of vehicle’s surroundings to the AV stack 506.

The environment health sensors 554 can monitor parameters for the state sensors 582 (e.g., camera, LIDAR, RADAR, etc.) to detect any diminished capability of these sensors to detect various aspects of the environment surrounding the vehicle (e.g., pedestrians, other vehicles, objects, etc.). The sensors 554 provide data 555 relating to performance of the sensors 582 to system monitor 508. The provided data can include an indication, for example, that a camera sensor is blocked, the LIDAR is malfunctioning, etc.

FIG. 6 illustrates an exemplary method 600 for selecting an optimal MRM, according to some embodiments of the current subject matter. The method 600 can be performed by one or more components of one or both systems 500, 599 as shown in FIGS. 5A-B, respectively. In some embodiments, the system controller 510 executes one or more operations associated with the method 600. At 602, the system controller 510 receives data related to at least one first parameter associated with a characteristic of a vehicle and at least one second parameter associated with at least one object (e.g., other vehicles, pedestrians, etc.) that may be external to the vehicle. The received parameters include current states as well as any predicted future states of data associated with the parameters.

The first parameter data can be provided from one or more of the vehicle health and/or state sensors 502, 552, 581, as shown in FIGS. 5A-B, respectively. The second parameter data can be provided from one or more of the environment health and/or state sensors 504, 554, 582, as shown in FIGS. 5A-B, respectively. In some embodiments, the system controller 510 can separately receive a third parameter data indicative of the state of the vehicle and/or the environment.

The system controller 510 receives actual or current state data associated with the monitored parameters from the AV stack 506 and/or the system monitor 508. The system monitor 508 can determine any future or predicted states of the parameters (e.g., a temperature of the vehicle’s transmission will exceed recommended temperature in one hour, a vehicle travelling in an opposite lane is expected to turn left, etc.). In some embodiments, the data associated with the parameters provided to the system controller 510 can include stochastic measurements (e.g., speed, position, acceleration, direction of movement, and/or any other measurements and/or any combination thereof).

In some embodiments, at 604, to generate and/or determine any future or predicted states of one or more vehicle/environment health/state parameters, the system 500, 599 performs modeling of the parameters. In some example embodiments, modeling is performed using a Markov decision process (MDP). The MDP can be defined as follows: M = (S, A, T, R). M designates MDP. S designates a vector representing one or more stochastic measurements of the vehicle (state and/or health) and/or environment (state and/or health). A designates a finite set of actions that can be performed (e.g., by the vehicle) based on the measurement vector S. For example, A = [C, MRM 1, MRM 2,... MRM N], where C means the AV stack 506 continues to control operation of the vehicle, and MRM refers to one or more MRMs 520. T is a function that specifies a transition probability of the next state s′ in view of an action a that was performed at state s. The function T can be sampled from a system simulation. R designates a reward R(s, a, s′) that is assigned corresponding to the transition. The reward function can be designed to dis-incentivize any unnecessary MRM transitions. For example, as stated above, the system 500, 599 assigns a positive reward (e.g., motivation) for the correctly selected MRM. A negative reward is assigned for an incorrectly or unnecessarily selected/used MRM. The system 500, 599 assigns an infinitely negative reward for an MRM that results in an accident, injury, damage to the vehicle, damage to the environment, etc. The system 500, 599 assigns rewards using rules 524. The system safety controller 510 uses assigned rewards to determine whether or not a specific situation warrants use of the MRM with such a reward assigned.

Referring back to FIG. 6, at 606, the controller 510 selects at least one maneuver, e.g., MRM 1, from a plurality of maneuvers (i.e., MRMs 520). The systems 500, 599 can store a predetermined number of MRMs 520. The controller 510 selects such MRM based on the generated future state(s). For example, the controller 510 determines that another vehicle is entering the vehicles travelling lane, and determines that the vehicle should slow down to avoid the turning vehicle.

Once the MRM has been selected, the system safety controller 510 determines at least one reward value associated with the selected MRM, at 608. As stated above, reward values can be determined using a Markov decision process reward function R. The reward values can be based on one or more safety rules 524 that are stored by the system 500 (e.g., stop at a stop sign, etc.). The controller 510 assigns a positive reward for a correctly selected MRM, a negative reward for an incorrectly selected MRM (e.g., operation of the vehicle in an unnecessary manner), and an infinitely or maximum negative reward for a clear violation of stored rules 524.

Once the reward value has been assigned to the selected MRM, the controller 510 determines, whether the selected MRM is the correct MRM in view of the parameter data it received from the sensors and/or determined through modeling. For example, if a positive reward was assigned to the initially selected MRM, the controller 510 can determine that the MRM should be executed by the vehicle’s operating systems and provide it to the drive by wire component 514 to execute.

Otherwise, if the selected MRM has been assigned a negative reward, the controller 510 can determine that the selected MRM should still be executed in view of the parameter data it has received/determined. Alternatively, or in addition to, the controller 510 can determine that another MRM should be selected, as the currently selected MRM may be unfeasible under the vehicle’s/environment’s health and/or state.

Further, if an infinitely negative reward has been assigned to the selected MRM, the controller 510 can determine that another MRM should be selected. The controller 510 can also determine that because selection of such MRM caused assignment of an infinitely or maximum negative reward, any future selections of this MRM, in view of the vehicle’s/environment’s health and/or state data, should be and/or must be avoided.

The controller 510 also updates, at 610, the MRM 520 (whether the selected MRM and/or any other MRMs 520) using the assigned reward determination and/or received/modeled data relating to vehicle’s/environment’s health/state. For example, the selected MRM may be updated by adjusting speed of movement of the vehicle, turn radius, etc. The controller 610 then provides the updated MRM to the drive by wire component 514, at 612, for operating the vehicle using the updated MRM.

In some embodiments, the system(s) 500, 599 can execute training of the neural network component 512 of the system(s) 500, 599 for the purposes of determining one or more MRMs and/or optimal MRMs for use in specific scenarios. The system(s) 500, 599 can perform training during offline (e.g., when the vehicle is not driving/operating). The determined MRMs can be invoked by the system(s) 500, 599 at drive time (e.g., when the vehicle is driving/operating).

For the training, the system(s) 500, 599 receive parameters that describe the current and future states of the vehicle and/or any other objects (e.g., other vehicles, pedestrians, objects (movable, immovable, etc.), etc.). The parameters can include, for example, but are not limited to, position, velocity, acceleration and headings of the vehicle and/or any other objects. The system controller 510 of the system(s) 500, 599 continuously receives data associated with one or more of the above parameters. The controller 510 can receive such data at drive time and generate one or more updates to a policy for selecting MRMs. The controller 510 executes updates continuously and/or at predetermined timed intervals. Moreover, the controller 510 outputs a trigger signal and/or a flag that indicates whether or not to execute an MRM and if an MRM is to be executed, which MRM from a discrete set of MRM is the optimal MRM to execute in particular situation.

FIG. 7 illustrates an exemplary method 700 for training a model for selection of an optimal MRM, according to some embodiments of the current subject matter. The method 700 can be performed by one or more components of one or both systems 500, 599. In some embodiments, the system controller 510 executes one or more operations associated with the method 700.

As shown in FIG. 7, at 702, the system controller 510 receives data related to at least one first parameter associated with a characteristic of a vehicle and at least one second parameter associated with at least one object (e.g., other vehicles, pedestrians, etc.) that may be external to the vehicle. The received parameters include current states as well as any predicted future states of data associated with the parameters.

Similar to the method 600 shown in FIG. 6, one or more of the vehicle health and/or state sensors 502, 552, 581, as shown in FIGS. 5A-B, respectively, provide the first parameter data. Likewise, one or more of the environment health and/or state sensors 504, 554, 582, as shown in FIGS. 5A-B, respectively, provide the second parameter data.

The system controller 510 receives actual or current state data associated with the monitored parameters from the AV stack 506 and/or the system monitor 508. The system monitor 508 determines any future or predicted states of the parameters. In some embodiments, the parameter data include stochastic measurements (e.g., speed, position, acceleration, direction of movement, and/or any other measurements and/or any combination thereof).

In some embodiments, at 704, to generate and/or determine any future or predicted states of one or more vehicle/environment health/state parameters, the system 500, 599 performs modeling of the parameters. In some example embodiments, modeling is performed using a Markov decision process (MDP), as discussed above in connection with FIG. 6.

At 706, the controller 510 performs training of at least one model (e.g., MRM model hosted by the neural network component 512) using one or more of the first and second received parameters. The controller 510 performs training during simulations (e.g., when the vehicle is not operating/driving). Alternatively, or in addition to, the controller 510 performs training at drive time. In some embodiments, any received data (e.g., vehicle’s/environment’s health/state data) can be annotated (e.g., manually, automatically, using an unsupervised technique, etc.) with an ideal or optimal corresponding MRM. The data and corresponding annotations are provided to train the MRM model hosted by the neural network component 512. Upon completion of the training, the trained MRM model is implemented in the AV stack 506. Further, for training purposes, the reward function component 522 receives one or more the same inputs as those that are received by the neural network component 512 (e.g., vehicle’s/environment’s state/health data). The reward function component 522 also receives information related to MRMs that are stored by the system(s) 500, 599, optimal MRMs that are selected in specific scenarios, and/or any other information related to MRMs. Additionally, the safety rules component 524 supplies to the reward function component 522 data associated with one or more safety rules (e.g., stop at a stop sign, etc.).

Based on the received information, the reward function component 522 outputs an indication (e.g., a flag signal, a trigger signal, etc.) of whether an MRM should be used and if so, which MRM should be used, and/or whether selected MRM is an optimal MRM. Upon the trigger signal indicating that the selected MRM can be used to operate the vehicle, the controller 510 can transmit a signal to the drive by wire component 514 to instruct it to operate the vehicle using the selected MRM. Alternatively, if the trigger signal indicates that the selected MRM cannot be used to operate the vehicle, the controller 510 can prevent operation of the vehicle using the selected MRM and select another MRM from the plurality of MRMs. In some embodiments, the trigger signal can indicate which MRM to select for a particular scenario.

The reward function component 522 also generates one or more rewards associated with one or more MRMs. As discussed above, the rewards can be positive (e.g., motivation), negative, and/or maximum/infinite negative rewards. The rewards are used to train the MRM model hosted by the neural network component 512.

In some embodiments, as a result of the training method 700, the controller 510 can generate new MRMs and store them for future use. New MRMs can be based on the parameter data that it continuously receives and the trained MRM model. The controller 510 can also update existing MRMs based on such continuous receipt of parameter data and the trained MRM model. Since the parameter data is continuously supplied, the controller 510 can also perform continuous training of the MRM model. In some embodiments, the controller 510 can generate MRMs and/or select MRMs (e.g., using the trained MRM model) while the vehicle is operating.

In view of the above, the current subject matter allows dynamic selection of an optimal MRM for a particular driving scenario and training an MRM model for use by the vehicle at drive time to assist in such selection of the optimal MRM during driving/operation. Because the dynamic selection/training processes account for various monitored parameter data related to the vehicle and/or its surrounding environment and relies on reinforcement learning (i.e., through reward assignment), selection/use of unintended/unnecessary MRMs can be avoided.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method, comprising:
receiving, using at least one processor, at least one first parameter associated with a characteristic of a vehicle and at least one second parameter associated with at least one object external to the vehicle;
generating, using the at least one processor, at least one future state for at least one of the at least one first parameter and the at least one second parameter;
selecting, using the at least one processor, at least one maneuver from a plurality of maneuvers based on the generated at least one future state;
determining, using the at least one processor, at least one reward value associated with the selected at least one maneuver;
updating, using the at least one processor, the selected at least one maneuver based on the determined at least one reward value to generate an updated at least one maneuver; and
causing the vehicle to operate based on the updated at least one maneuver.

2. The method according to claim 1, wherein the determining further comprises
determining, using the at least one processor, the at least one reward value using a reinforcement learning process, the reinforcement learning process being executed, using the at least one processor, based on at least one rule associated with operating of the vehicle.

3. The method according to claim 2, wherein the at least one reward includes at least one of the following: a maximum negative reward for violating the at least one rule, a negative reward for operating the vehicle in an unnecessary manner, a positive reward, and any combination thereof.

4. The method according to claim 1, wherein
the at least one first parameter includes at least one of a current state and a predicted future state associated with operation of the vehicle; and
the at least one second parameter includes at least one of a current state and a predicted future state associated with the object.

5. The method according to claim 1, wherein the receiving further comprises
receiving, using the at least one processor, data corresponding to at least one stochastic measurement associated with at least one of the at least one first parameter and the at least one second parameter.

6. The method according to claim 1, wherein the at least one first parameter and the at least one second parameter include at least one of the following: a speed, a position, an acceleration, a direction of movement, and any combination thereof.

7. The method according to claim 1, wherein the at least one object includes at least one of the following: at least one another vehicle, at least one moving object, at least one stationary object, and any combination thereof.

8. The method according to claim 1, wherein the receiving further comprises
receiving, using the at least one processor, at least one third parameter associated with an operational ability of the vehicle.

9. The method according to claim 8, wherein the selecting further comprises
selecting, using the at least one processor, the at least one maneuver based on the determined at least one future state and the at least one third parameter.

10. The method according to claim 1, wherein the generating further comprises
modeling, using the at least one processor, at least one of the at least one first parameter and the at least one second parameter to generate the at least one future state.

11. The method according to claim 10, wherein the modeling further comprises,
modeling, using the at least one processor, at least one of the at least one first parameter and the at least one second parameter using a Markov decision process.

12. A system, comprising:
at least one processor, and
at least one non-transitory storage media storing instructions that, when executed by the at least one processor, cause the at least one processor to perform operations comprising:
receiving, using the at least one processor, at least one first parameter associated with a characteristic of a vehicle and at least one second parameter associated with at least one object external to the vehicle;
generating, using the at least one processor, at least one future state for at least one of the at least one first parameter and the at least one second parameter;
selecting, using the at least one processor, at least one maneuver from a plurality of maneuvers based on the generated at least one future state;
determining, using the at least one processor, at least one reward value associated with the selected at least one maneuver;
updating, using the at least one processor, the selected at least one maneuver based on the determined at least one reward value to generate an updated at least one maneuver; and
causing the vehicle to operate based on the updated at least one maneuver.

13. At least one non-transitory storage media storing instructions that, when executed by at least one processor, cause the at least one processor to perform operations comprising:
receiving, using the at least one processor, at least one first parameter associated with a characteristic of a vehicle and at least one second parameter associated with at least one object external to the vehicle;
generating, using the at least one processor, at least one future state for at least one of the at least one first parameter and the at least one second parameter;
selecting, using the at least one processor, at least one maneuver from a plurality of maneuvers based on the generated at least one future state;
determining, using the at least one processor, at least one reward value associated with the selected at least one maneuver;
updating, using the at least one processor, the selected at least one maneuver based on the determined at least one reward value to generate an updated at least one maneuver; and causing the vehicle to operate based on the updated at least one maneuver.

14. A method, comprising:
receiving, using at least one processor, at least one first parameter associated with a characteristic of a vehicle and at least one second parameter associated with at least one object external to the vehicle;
determining, using the at least one processor, at least one future state for at least one of the at least one first parameter and the at least one second parameter; and
training, using the at least one processor, at least one model using at least one of the at least one first parameter and the at least one second parameter.

15. The method according to claim 14, further comprising generating, using the at least one processor, at least maneuver based on the trained model to operate the vehicle.

16. The method according to claim 14, wherein
the at least one first parameter includes at least one of a current state and a predicted future state associated with the vehicle; and
the at least one second parameter includes at least one of a current state and a predicted future state associated with the object.

17. The method according to claim 14, wherein the receiving further comprises
continuously receiving, using the at least one processor, at least one of the at least one first parameter and the at least one second parameter.

18. The method according to claim 17, wherein the training further comprises
continuously training, using the at least one processor, the at least one model using continuously received at least one of the at least one first parameter and the at least one second parameter.

19. The method according to claim 14, wherein the generating further comprises
selecting, using the at least one processor, the at least one maneuver from a plurality of maneuvers;
generating, using the at least one processor, at least one trigger signal associated with the selected at least one maneuver can be used to operate the vehicle; and
upon the at least one trigger signal indicating that the selected at least one maneuver can be used to operate the vehicle, operating the vehicle using the at least one maneuver;
upon the at least one trigger signal indicating that the selected at least one maneuver cannot be used to operate the vehicle, preventing operation of the vehicle using the selected at least one maneuver and selecting at least another maneuver from the plurality of maneuvers based on the generated at least one trigger signal to operate the vehicle.

20. The method according to claim 14, wherein the generating the at least one maneuver further comprises
generating, using the at least one processor, the at least one maneuver while the vehicle is operating.

21-25. (canceled)
